(19) United States
(12) Patent Application Publication
(10) Pub. No.: US 2020/0214928 A1
(43) Pub. Date: Jul. 9, 2020

(54) DOUBLE ROLLER MASSAGE DEVICE

(71) Applicant: LULULEMON ATHLETICA CANADA INC., VANCOUVER (CA)

(72) Inventors: STEPHEN THOMAS CAULTON MORRIS, VANCOUVER (CA); COLTON KAI YU, VANCOUVER (CA); WARREN CHRISTOPHER HOWREN CHENG, VANCOUVER (CA)

(21) Appl. No.: 16/729,380

(22) Filed: Dec. 28, 2019

Related U.S. Application Data
(60) Provisional application No. 62/788,018, filed on Jan. 3, 2019.

(51) Int. Cl. A61H 15/00

(52) U.S. Cl. CPC A61H 15/00; A61H 2015/0021; A61H 2201/169; A61H 2201/0107; A61H 2205/081; A61H 2201/0103

(57) ABSTRACT

A massage device, comprising: a hollow cylindrical outer roller having a first texture formed on an outer surface thereof; and, a cylindrical inner roller having a second texture formed on an outer surface thereof and sized to fit concentrically within the hollow cylindrical outer roller; wherein the cylindrical inner roller is moveable between a first position within the hollow cylindrical outer roller and a second position outside of the hollow cylindrical outer roller.

This application claims priority from and the benefit of the filing date of United States Provisional Patent Application No. 62/788,018, filed Jan. 3, 2019, and the entire content of such application is incorporated herein by reference.

### FIELD OF THE APPLICATION

This application relates to the field of massage devices, and more specifically, to foam roller type massage and exercise devices.

### BACKGROUND OF THE APPLICATION

Consumers are demanding high performance, flexible, and effective massage devices. This is especially so for consumers engaged in sports and activities such as running, yoga, and swimming that typically require stretching and massage both before and after performance. In addition, consumers are demanding massage devices that are effective in massaging and relieving pain and discomfort associated with tight muscles as well as other muscle or connective tissue ailments such as trigger points, foot pain, Achilles tendon ailments, plantar fasciitis, calf and heel pain, carpel tunnel syndrome, lower back pain, hip pain and thigh pain, etc. Such massage devices should provide an effective massage but must also be light weight and portable to allow the user to take them to the studio, gym, or pool for use before and after exercising and other athletic performance.

One problem with existing massage rollers is that they often suitable for massaging only a limited number of muscle groups. In addition, such rollers are limited in the number of textured surfaces that contact the user's body requiring the user to employ different devices to control the level and intensity of massage and so obtain a satisfactory and effective massage.

A need therefore exists for improved massage device. Accordingly, a solution that addresses, at least in part, the above and other shortcomings is desired.

### SUMMARY OF THE APPLICATION

According to one aspect of the disclosure, there are provided a massage device, comprising: a hollow cylindrical outer roller having a first texture formed on an outer surface thereof; and, a cylindrical inner roller having a second texture formed on an outer surface thereof and sized to fit concentrically within the hollow cylindrical outer roller; wherein the cylindrical inner roller is moveable between a first position within the hollow cylindrical outer roller and a second position outside of the hollow cylindrical outer roller.

### BRIEF DESCRIPTION OF THE DRAWINGS

Features and advantages of the embodiments of the present application will become apparent from the following detailed description, taken in combination with the appended drawings, in which:

FIG. 1 is a front view illustrating a massage device shown with the inner roller thereof fully inserted into the outer roller thereof in accordance with an embodiment of the application;

FIG. 2 is a rear view thereof;

FIG. 3 is a right side end view thereof;

FIG. 4 is a left side end view thereof;

FIG. 5 is a front perspective view thereof;

FIG. 6 is a rear perspective view thereof;

FIG. 7 is a front perspective environmental view thereof showing use of the massage device of FIG. 1 by a user;

FIG. 8 is a rear perspective view of the massage device of FIG. 1 illustrating movement of the inner roller between first and second positions in accordance with an embodiment of the application;

FIG. 9 is a front view illustrating the outer roller of the massage device of FIG. 1 in accordance with an embodiment of the application;

FIG. 10 is a rear view thereof;

FIG. 11 is a right side end view thereof;

FIG. 12 is a left side end view thereof;

FIG. 13 is a front perspective view thereof;

FIG. 14 is a rear perspective view thereof;

FIG. 15 is a front perspective environmental view thereof showing use of the outer roller of the massage device by a user (i.e., use of the outer roller alone);

FIG. 16 is a front view illustrating the inner roller of the massage device of FIG. 1 in accordance with an embodiment of the application;

FIG. 17 is a rear view thereof;

FIG. 18 is a right side end view thereof;

FIG. 19 is a left side end view thereof;

FIG. 20 is a front perspective view thereof;

FIG. 21 is a rear perspective view thereof;

FIG. 22 is a front perspective environmental view thereof showing use of the inner roller of the massage device by a user (i.e., use of the inner roller alone);

FIG. 23 is a cross-sectional view of the massage device of FIG. 1 taken along line 23-23 in FIG. 3 in accordance with an embodiment of the application;

FIG. 24 is a cross-sectional view of the outer roller of the massage device of FIG. 1 taken along line 24-24 in FIG. 9 in accordance with an embodiment of the application;

FIG. 25 is a cross-sectional view of the inner roller of the massage device of FIG. 1 taken along line 25-25 in FIG. 16 in accordance with an embodiment of the application; and,

FIG. 26 is a cross-sectional view of the massage device of FIG. 1 taken along line 23-23 in FIG. 3 in accordance with another embodiment of the application.

It will be noted that throughout the appended drawings, like features are identified by like reference numerals.

### DETAILED DESCRIPTION OF EXAMPLE EMBODIMENTS

In the following description, details are set forth to provide an understanding of the application. In some instances, certain structures, techniques, and methods have not been described or shown in detail in order not to obscure the application.

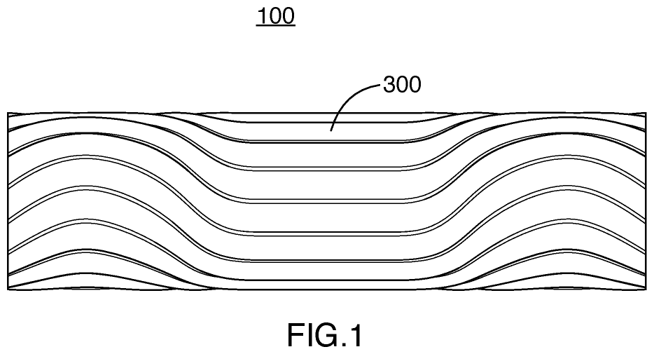

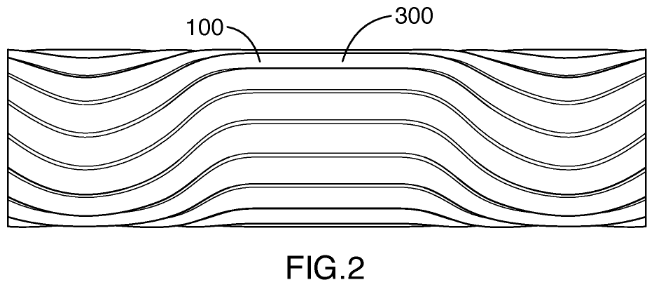

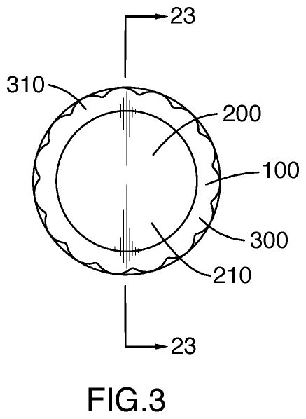

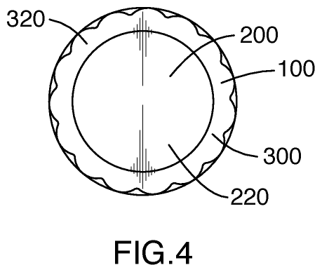

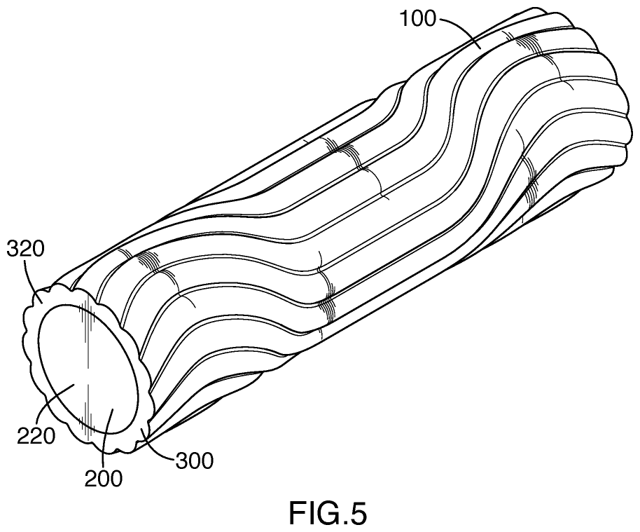

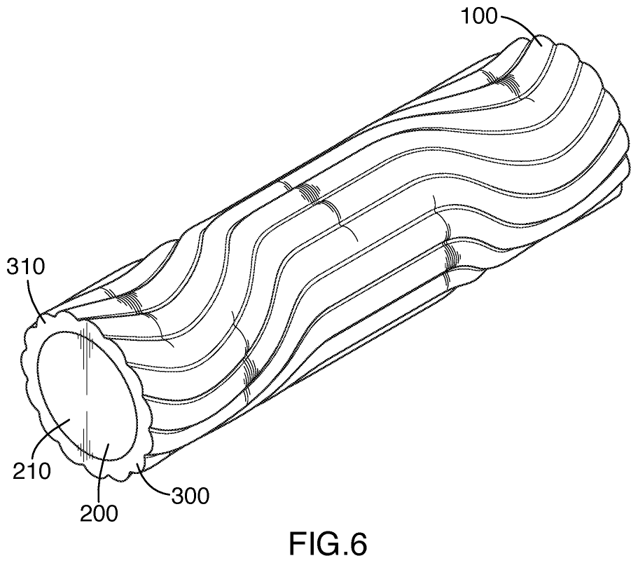

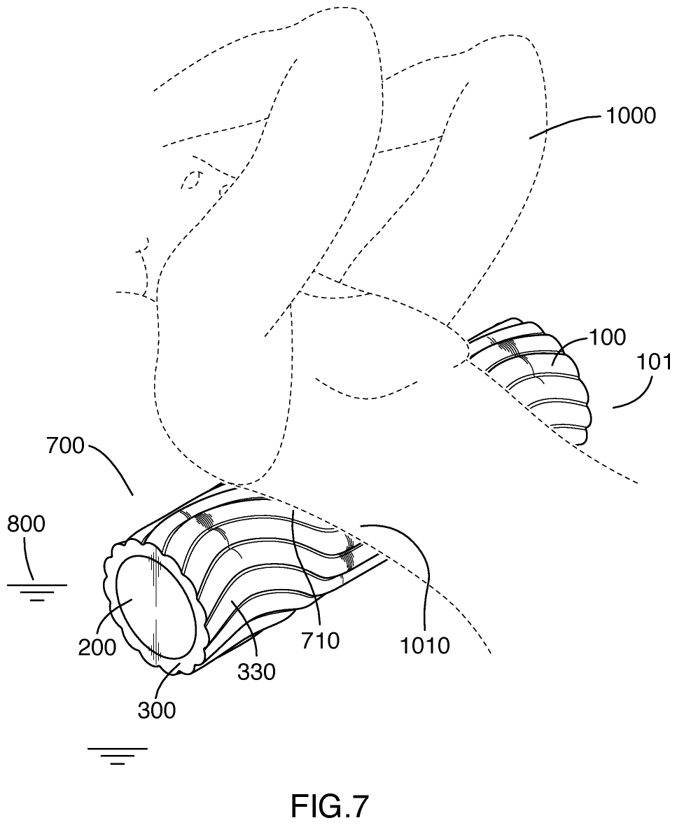

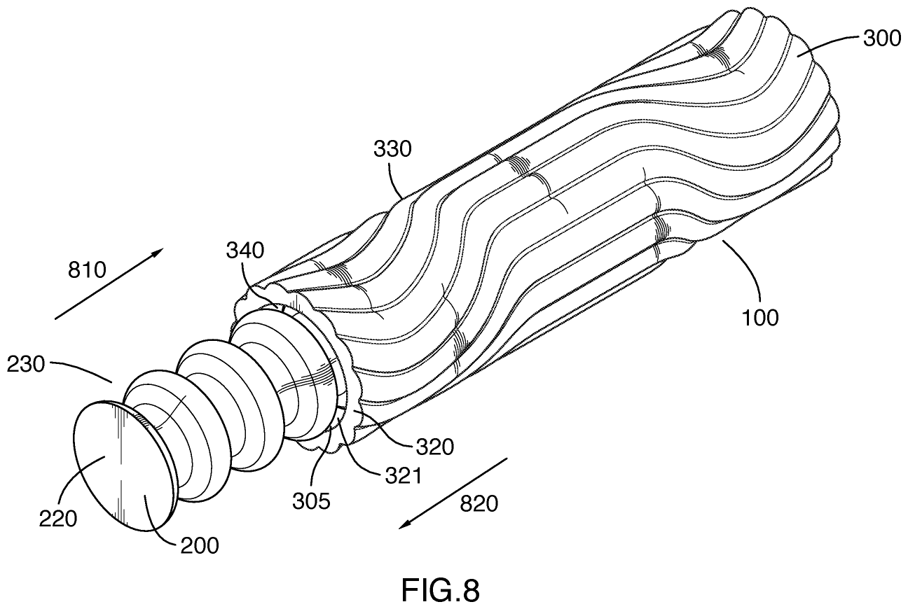

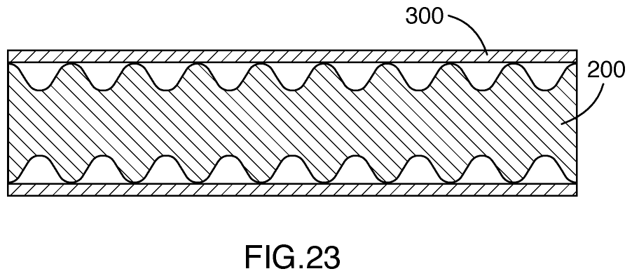

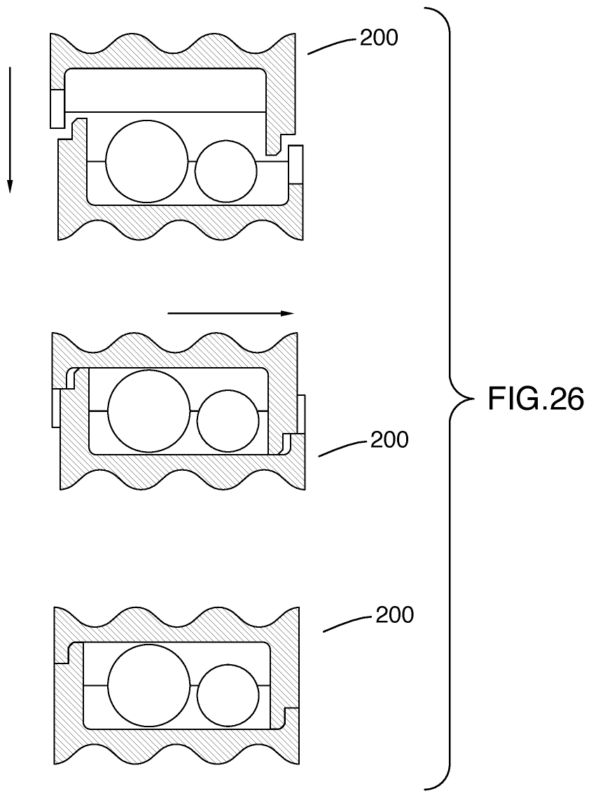

FIG. 1 is a front view illustrating a massage device 100 shown with the inner roller 200 thereof fully inserted into the outer roller 300 thereof in accordance with an embodiment of the application. FIG. 2 is a rear view thereof. FIG. 3 is a right side end view thereof. FIG. 4 is a left side end view thereof. FIG. 5 is a front perspective view thereof. FIG. 6 is a rear perspective view thereof. FIG. 7 is a front perspective environmental view thereof showing use of the massage device 100 of FIG. 1 by a user 1000. FIG. 8 is a rear perspective view of the massage device 100 of FIG. 1 illustrating movement of the inner roller 200 between first and second positions 101, 102 in accordance with an embodiment of the application. FIG. 23 is a cross-sectional view of the massage device 100 of FIG. 1 taken along line 23-23 in FIG. 3 in accordance with an embodiment of the application. And, FIG. 26 is a cross-sectional view of the massage device of FIG. 1 taken along line 23-23 in FIG. 3 in accordance with another embodiment of the application.

According to one embodiment of the application, a massage device 100 is provided. The massage device 100 may be used by a user to massage various muscle groups of the user's body 1000 as further described below. The massage device 100 is a cylindrical double roller having a hollow cylindrical outer roller 300 into which a removable or separable solid (or hollow) cylindrical inner roller 200 is inserted. The massage device 100 may be used in a first configuration 700 in which the inner roller 200 is inserted (e.g., fully inserted) into the outer roller 300 and the two rollers 200, 300 are used together, a second configuration 1500 in which the inner roller 200 is used alone, and an optional third configuration 2200 in which the outer roller 300 is used alone. These configurations 700, 1500, 2200 are further described below.

Referring to FIG. 8, the inner roller 200 may be sized to fit concentrically within the hollow outer roller 300. The fit between the outer surface 230 of the inner roller 200 and the inner surface 340 of the outer roller 300 may be a snug or friction fit to hold the inner roller 200 in place within the outer roller 300 during use or transport of the massage device 100. The inner roller 200 may be moved between a first position 101 inside or combined or inserted in the outer roller 300 and a second position 102 outside or separate or removed from the outer roller 300. To insert the inner roller 200 into the outer roller 300, one end (e.g., 210) of the inner roller 200 may be inserted into the inside 305 of the outer roller 300 through the opening (e.g., 321) formed in one end (e.g., 320) of the outer roller 300 and the opposite end (e.g., 220) of the inner roller 200 may be pushed in an axial direction 810 until the inner roller 200 is fully inside the outer roller 300 (i.e., the ends 210, 220 of the inner roller 200 are flush with the respective ends 310, 320 of the outer roller 300). Similarly, to remove the inner roller 200 from the outer roller 300, one end (e.g., 210) of the inner roller 200 may be pushed in an axial direction 820 through the inside 305 of the outer roller 300 until the inner roller 200 is clear of the outer roller 300.

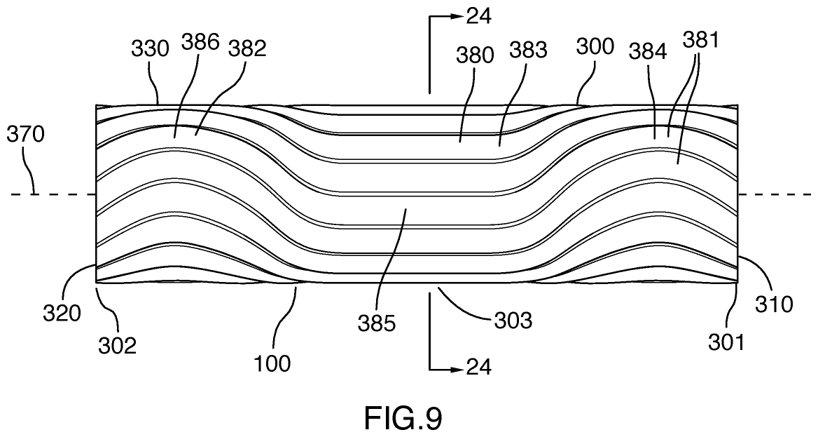

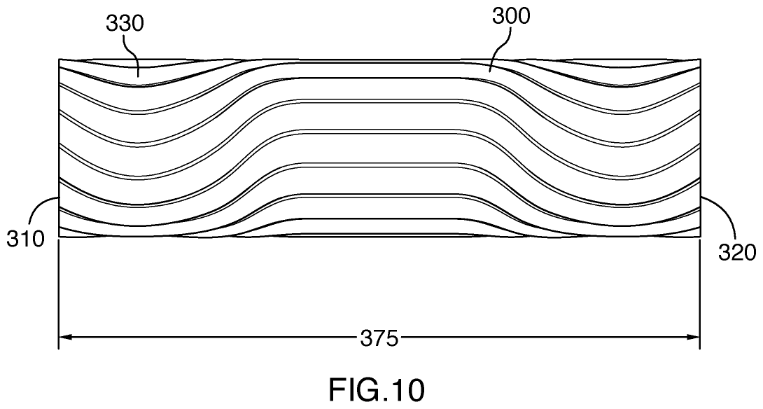

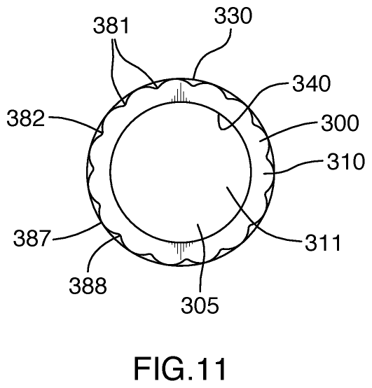

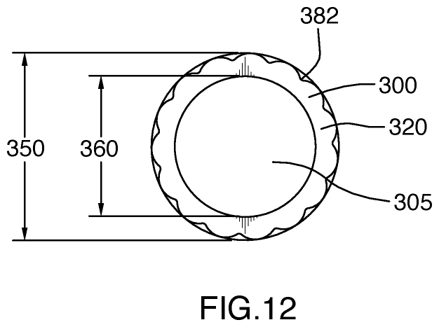

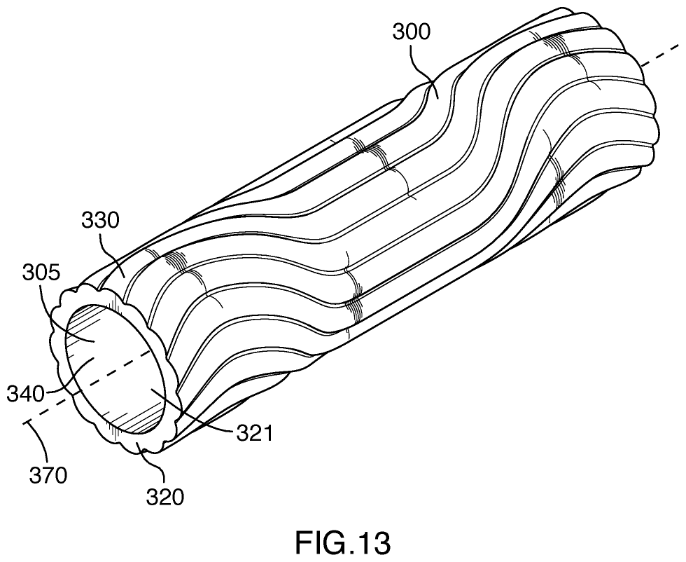

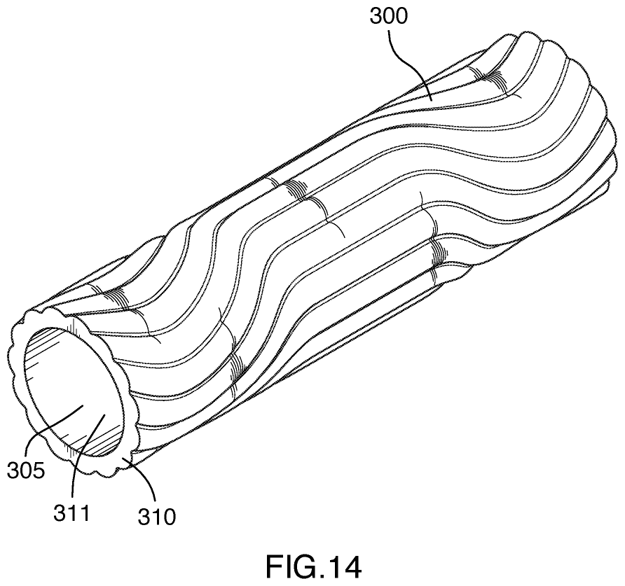

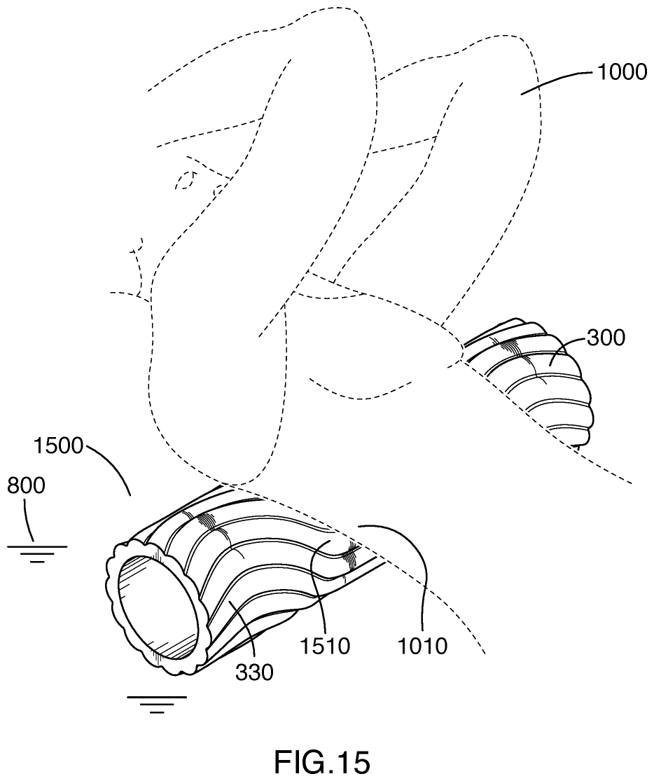

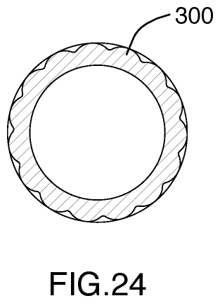

FIG. 9 is a front view illustrating the outer roller 300 of the massage device 100 of FIG. 1 in accordance with an embodiment of the application. FIG. 10 is a rear view thereof. FIG. 11 is a right side end view thereof. FIG. 12 is a left side end view thereof. FIG. 13 is a front perspective view thereof. FIG. 14 is a rear perspective view thereof. FIG. 15 is a front perspective environmental view thereof showing use of the outer roller 300 of the massage device 100 by a user 1000 (i.e., use of the outer roller 300 alone). And, FIG. 24 is a cross-sectional view of the outer roller 300 of the massage device of FIG. 1 taken along line 24-24 in FIG. 9 in accordance with an embodiment of the application.

According to one embodiment, the outer roller 300 is an elongate, hollow, cylinder having a first or right base or end surface 310 at a first or right end 301 thereof, a second or left base or end surface at a second of left end 302 thereof, an outer surface 330, an inner surface 340, an outside diameter 350, an inside diameter 360, a central axis 370 (i.e., a line formed through the centres of the base surfaces 310, 320 of the cylinder 300), and an axial length 375. Each end surface 310, 320 may have a respective circular opening 311, 321 formed therein for providing access to the inside 305 of the outer roller 300. In one implementation, the outer cylinder may have an opening (e.g., opening 311) formed in one of the end surfaces while the opposite end surface may be closed. Such opening may provide access to the inside 305 of the outer roller 300.

In one embodiment, the outer roller 300 may have an outside diameter 350 of 132 mm or approximately 132 mm, an inside diameter 360 of 106 mm or approximately 106 mm, and an axial length 375 of 508 mm or approximately 508 mm. These dimensions are provided for illustration purposes only and the outer roller may have different dimensions without departing from the scope of the application. According to one embodiment, the first and second end surfaces 310, 320 of the outer roller 300 may be flat or approximately flat surfaces.

In one embodiment, the inner surface 340 of the outer roller 300 may be formed as a smooth surface to reduce friction between the inner and outer rollers 200, 300 when moving the inner roller 200 between its first and second positions 101, 102. According to another embodiment, a smooth lining (not shown) may be applied or attached to the inner surface 340 of the outer roller 300 to reduce friction between the inner and outer rollers 200, 300 when moving the inner roller 200 between its first and second positions 101, 102.

According to one embodiment, the outer surface 330 of the outer roller 300 has a first texture (e.g., feel, appearance, roughness, smoothness, softness, hardness, etc.) 380 formed thereon. The first texture 380 may be selected to provide an effective massage for a specific muscle group of the user's body 1000 as further described below. Of course, the outer roller 300 may also be used to massage any part of the body that the user chooses.

In one embodiment, the first texture 380 may be formed by or consist of a plurality (e.g., 15) of longitudinal grooves 381 formed in the outer surface 330 of the outer roller 300. Each longitudinal groove (e.g., 382) extends between the first and second ends 301, 302 of the outer roller 300 and traces out a transverse wave-shaped pattern 383 having a first crest or curved portion (or first massage zone) 384 proximate the first end 301 of the outer roller 300, an elongate trough portion (or second massage zone) 385 proximate a midpoint (or approximate midpoint) 303 of the outer roller 300, and a second crest or curved portion (or third massage zone) 386 proximate the second end 302 of the outer roller 300. In one embodiment, the longitudinal grooves 381 may be interrupted along their length, for example between and first and second massage zones and/or between the second and third massage zones; and/or, the outer surface 330 of the outer roller 300 may be flat or have a different texture (e.g., a number of tabs).

In another embodiment, the outer roller 300 may further include a sleeve (not shown) that is extendable or placeable over the outer roller 300 such that the external surface of the sleeve forms the outer surface 330 of the outer roller 300. In other words, the outer roller 300 is insertable into the sleeve. In one embodiment, the sleeve may comprise one or more independent parts such that each part may be extended or placed over the outer roller 300 independently. Each part of the sleeve may cover only a portion of the outer roller 300. Each part of the sleeve may have a different texture such that when such parts are extended or placed over the outer roller 300 and positioned along the length of the outer roller 300 they form an outer surface 330 having different massage zones. Using one or more sleeves, the user may choose different textures which may be easily changed by changing the sleeve or part of the sleeve.

In one embodiment, the axial length of the first and third massage zones 384, 386 may be 214 mm or approximately 214 mm and the length of the second massage zone 385 may be 80 mm or approximately 80 mm. These dimensions are provided for illustration purposes only and the massage zones 384, 385, 386 may have any other lengths without departing from the scope of the application. In one embodiment, the portion of the wave-shaped pattern 383 extending from the first end 301 of the outer roller 300 to the midpoint 303 thereof may be a mirror image of the portion of the wave-shaped pattern 383 extending from the second end 302 of the outer roller 300 to the midpoint 303 thereof.

According to one embodiment, at least some of the longitudinal grooves 382 are V-shaped (or approximately V-shaped) in cross-section or sinusoidal (or approximately sinusoidal) in cross-section (as shown in FIG. 24). For illustration purposes only, the longitudinal groove 382 may have a depth from crest 387 to trough (or root) 388 of 8 mm or approximately 8 mm and a spacing from crest 387 to crest 389 of 25 mm or approximately 25 mm. Alternatively, the depth from crest 387 to root 388 and/or the spacing from crest 387 to crest 387 may increase or decrease between adjacent grooves.

According to another embodiment, the longitudinal grooves 381 may have a straight, diagonal, zig-zag or annual pattern or any variations or combinations thereof. According to a further embodiment, the first texture 380 of the outer roller 300 may be a smooth surface.

According to one embodiment, the outer roller 300 may be formed from a resilient closed cell foam or other resilient or pliant material. In one embodiment, the outer surface 330 of the outer roller 300 may be more compressible (i.e., softer or less dense) than that of the inner roller 200.

In one embodiment, the outer roller 300 may have a modular configuration. For example, the outer roller 300 may include two or more hollow cylinders (or modules) having the same or approximately the same diameter and wall thickness such that when the modules are positioned or placed adjacent or next to each other they form continuous outer and inner surfaces 330, 340. Each module may include a connector formed in proximity to the side edge thereof for joining the individual modules together. For example, the connector may be one of a Velcro™ tape, at least one magnet, or any type of scarf or lock & key joints or a combination thereof, that can provide for locking of the multiple modules together to form a single outer roller 300. Each of the modules may have a different texture and/or compressibility.

In one embodiment, the compressibility of the outer roller 300 may vary between the first and second ends 301, 302 of the outer roller 300. For example, the compressibility proximate the midpoint 303 of the outer roller (i.e., in the second massage zone 385) may be greater than the compressibility proximate the ends 301, 302 of the outer roller 300, or vise versa (i.e., in the first and third massage zones 384, 386).

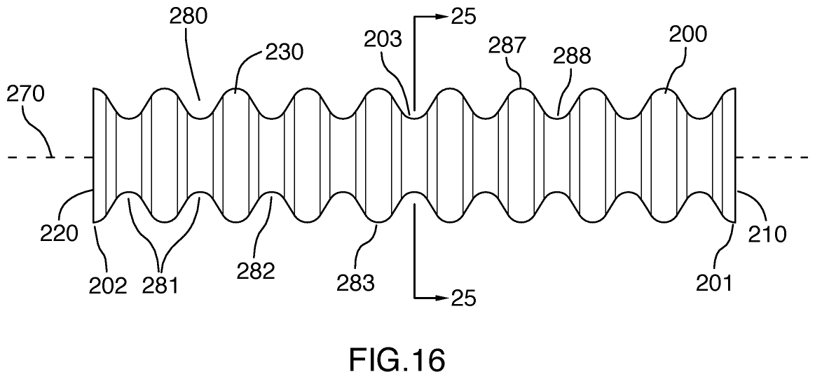

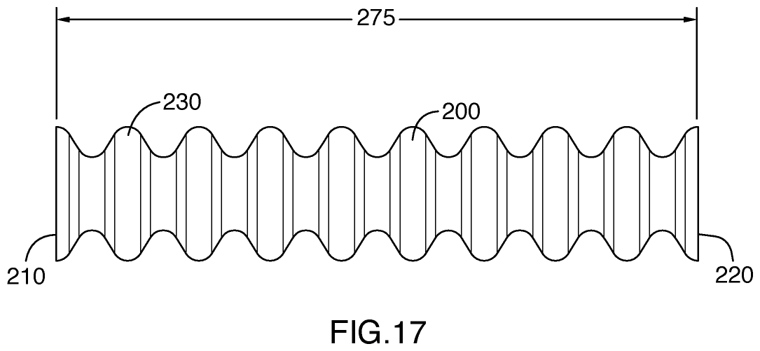

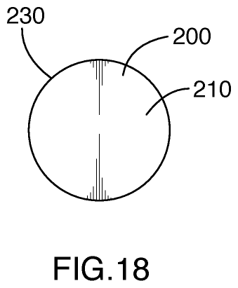

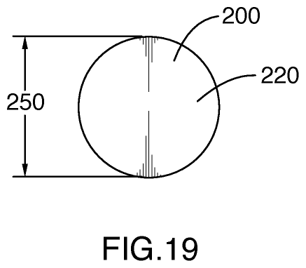

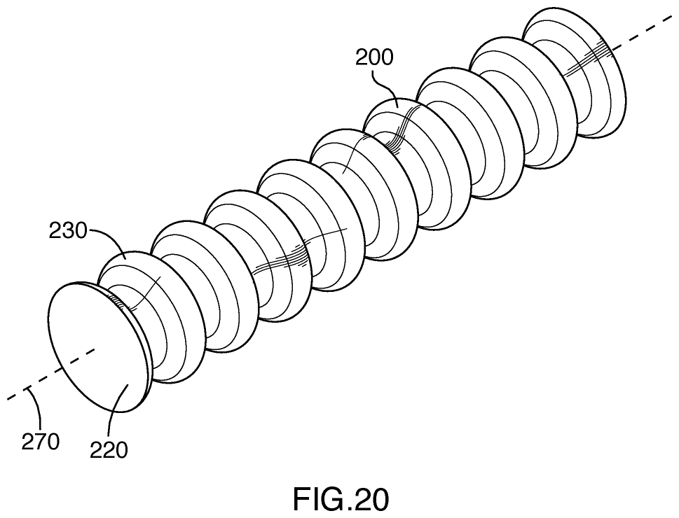

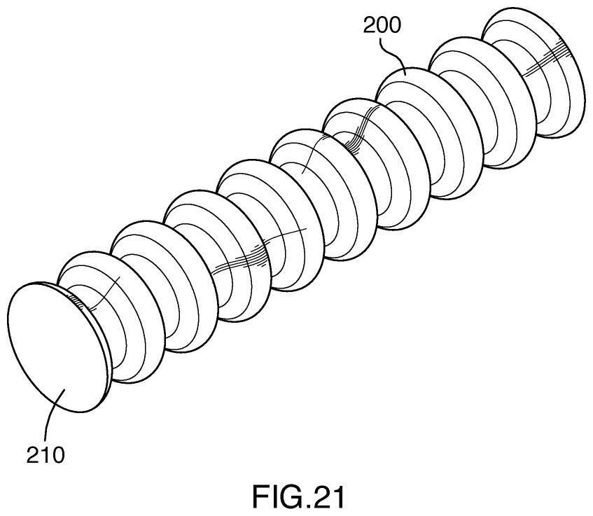

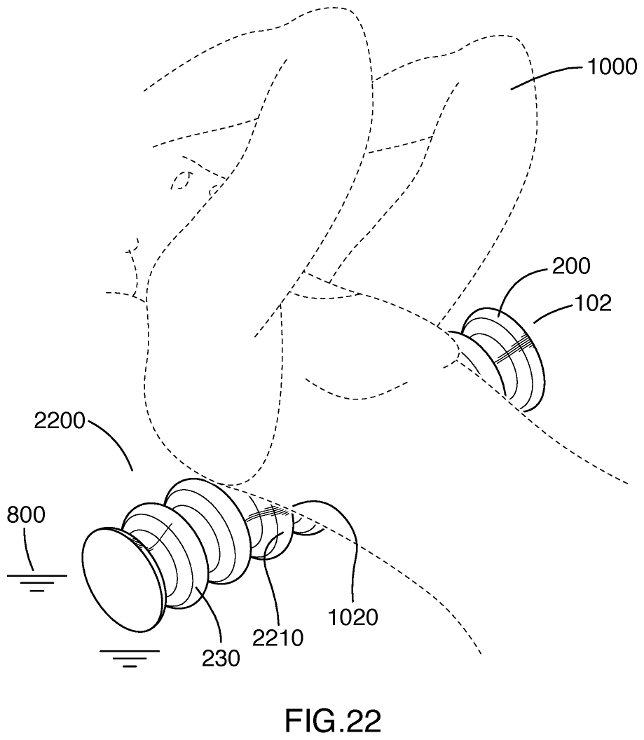

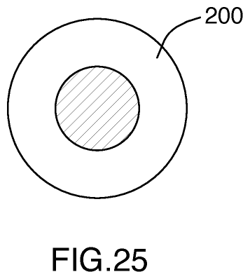

FIG. 16 is a front view illustrating the inner roller 200 of the massage device 100 of FIG. 1 in accordance with an embodiment of the application. FIG. 17 is a rear view thereof. FIG. 18 is a right side end view thereof. FIG. 19 is a left side end view thereof. FIG. 20 is a front perspective view thereof. FIG. 21 is a rear perspective view thereof. FIG. 22 is a front perspective environmental view thereof showing use of the inner roller 200 of the massage device 100 by a user 1000 (i.e., use of the inner roller 200 alone). And, FIG. 25 is a cross-sectional view of the inner roller 200 of the massage device 100 of FIG. 1 taken along line 25-25 in FIG. 16 in accordance with an embodiment of the application.

According to one embodiment, the inner roller 200 is an elongate, solid, right circular cylinder having a first or right base or end surface 210 at a first or right end 201 thereof, a second or left base or end surface 220 at a second or left end 202 thereof, an outer surface 230, an outside diameter 260, a central axis 270 (i.e., a line formed through the centres of the base surfaces 210, 220 of the cylinder 200), and an axial length 275.

The outside diameter 260 of the inner roller 200 is sized such that it can fit and snug within the outer roller 300. For example, the inner roller 200 may have an outside diameter of 105 mm or approximately 105 mm and an axial length 275 of 508 mm or approximately 508 mm. According to one embodiment, the lengths of the inner and outer rollers 200, 300 may be equal or approximately equal however the inner roller 200 can be shorter of longer than the outer roller 300 without departing from the scope of the invention. According to one embodiment, the first and second end surfaces 210, 220 of the inner roller 200 are flat or approximately flat surfaces. In one embodiment, the inner roller 200 may further include a handle (not shown) formed on, in, or at the first and/or the second end surfaces 210, 220. For example, the handle may be a handle bar extending outwardly from the end surface 210, 220. In one embodiment, the handle may be formed on only one end surface while the other end surface may be flat (i.e., has no handle thereon). In yet another embodiment, one or both of the end surfaces 210, 220 may have an indentation extending inwardly from the end surface 210, 220 forming the handle. The handle may be used to pull out or push in the inner roller 200 from the outer roller 300. In one embodiment, the one or two handles may be used to carry the massage device 100. The handles may be connected to the inner roller 200 or to the outer roller 300. The massage device 100 may include a belt with a connector on each end thereof for removably connecting to the handle on each end surface 210, 220.

In one embodiment, the outer surface 230 of the inner roller 200 has a second texture 280 forming thereon. The second texture 280 is selected to provide an effective massage for a specific muscle group of the user as further described below. Of course, the inner roller 320 may also be used to massage any part of the body that the user chooses.

According to one embodiment, the second texture 280 may be formed by or consist of a plurality (e.g., 9) of transverse grooves 281 formed in the outer surface 230 of the inner roller 200. Each transverse groove (e.g., 282) is an annual groove extending around the outer surface 230 of the inner roller 200. The transverse grooves 281 trace out a longitudinal wave-shaped pattern 283 that is uniform (i.e., uniform in height and depth) from the first end 201 to the second end 202 of the inner roller 200.

Alternatively, the transverse grooves 281 may trace out a longitudinal wave-shaped pattern that is non-uniform. For example, the height and depth of each transverse groove 282 may increase (or decrease) from the first end 201 of the inner roller 200 to the midpoint 203 thereof and then decrease (or increase) from the midpoint 203 thereof to the second end 202 of the inner roller 200. Alternatively, the depth from crest 287 to root 288 and/or the spacing from crest 287 to crest 289 may increase or decrease between adjacent grooves 281.

In one embodiment, the portion of the longitudinal wave-shaped pattern 283 extending from the first end 201 of the inner roller 200 to the midpoint 203 thereof may be a mirror image of the portion of the longitudinal wave-shaped pattern 283 extending from the second end 202 of the inner roller 200 to the midpoint 203 thereof.

In one embodiment, the transverse grooves 281 may be spaced along the length of the inner roller 200 such that each 201, 202 of the inner roller 200 ends at a groove crest 287 as shown in FIG. 16.

According to one embodiment, each transverse groove 282 is V-shaped (or approximately V-shaped) in cross-section or sinusoidal (or approximately sinusoidal) in cross-section. For illustration purposes only, each transverse groove 282 may have a depth from crest 287 to trough (or root) 288 of 20 mm or approximately 20 mm and a spacing from crest 287 to crest 287 of 55 mm or approximately 55 mm. According to one embodiment, the size of the grooves 281 on the inner roller 200 are larger than the size of the grooves 381 on the outer roller 300. In one embodiment, the second texture 280 may include a plurality of longitudinal grooves (e.g., similar to the longitudinal grooves of the outer roller 300). In yet another embodiment, the second texture 280 may include a plurality of spikes extending radially and outwardly from the outer surface 230. In one embodiment, the second texture 280 may have a textured pattern or combination of textured and smooth surfaces. In one embodiment, at least a portion (e.g., a middle portion) of the outer surface 230 of the inner roller 200 may be a smooth surface.

In one embodiment, the inner roller 200 may have a modular configuration. For example, the inner roller 200 may include two or more cylindrical modules with the same or approximately the same diameter and matching shapes such that when such modules are placed or positioned adjacent or next to each other they form a continuous outer surface 230. Each module may include a connector formed in proximity to the side edge thereof for joining the individual modules together. For example, the connector may be one of a Velcro™ tape, at least one magnet, or any type of scarf or lock & key joints or a combination thereof, that may provide for locking of the multiple modules together to form a single inner roller 200. Each of the modules may have a different texture and/or compressibility.

In yet another embodiment, the inner roller 200 may further include a sleeve (not shown) that is extendable or placeable over the inner roller such that the external surface of the sleeve forms the outer surface 230 of the inner roller 200. In other words, the inner roller 200 is insertable into the sleeve. In one embodiment, the sleeve may include one or more independent parts such that each part may be extended over the inner roller 200 independently. Each part of the sleeve may have different texture such that when such parts are extended over the inner roller 200 and positioned along the length of the inner roller, they form an outer surface 230 having different massage zones. Using one or more sleeves, the user may choose different textures which may be easily changed by changing the sleeve or part of the sleeve.

In one embodiment, the inner roller 200 may include two longitudinal halves as illustrated in FIG. 26. Each of the halves may include an outside wall, two end walls, and an inner hollow space such that when the two halves are joined together they form the inner roller 200 having closed ends and an inner cavity that may used for storage, for example, to store additional massage props or accessories. For example, one or more massage balls (or other sports balls) may be stored in the inner cavity of the roller 200, such that a user may open the two halves of the inner roller, take the balls out, and use them for a massage. The inner roller may be used with props stored in the inner cavity or with the inner cavity empty or hollow, that is, when the props are taken out of the inner cavity and the halves are joined together. The two halves may be detachably connected using any known connector. FIG. 26, for example, shows a dove tail joint closure, however, any other suitable connector may be used without departing from the scope of the application.

According to one embodiment, the inner roller 200 may be a hollow cylinder similar to the outer roller 300. According to another embodiment, the second texture 280 may be a smooth surface. In one embodiment, the second texture 280 may include a number of different textures that change axially along the length of the inner roller or radially. In one embodiment, the hollow inner roller 200 may have closed ends. An inflating port with a closure may be formed at one end to inflate or deflate the inner roller 200. By changing the pressure in the inner roller 200, a user may adjust/change the compressibility of the inner roller. In one embodiment, the inner cavity of the inner roller may include one or more pouches stacked therein that may be removably inserted into the inner roller 200. The pouches may be used for controlling the temperature of the inner roller 200. For example, the pouches may be microwavable to heat them up or may be placed in a freezer to cool them down before insertion into the inner roller 200. The one or more pouches may also be used in conjunction with the outer roller 300 for stacking the hollow inner cavity of the outer roller 300 when the inner roller 200 is removed from the outer roller 300.

According to one embodiment, the inner roller 200 may be formed from a resilient closed cell foam or other resilient or pliant material that is less compressible (i.e., harder or more dense) than that of the outer roller 300.

In one embodiment, the inner roller 200 may include a ball that may be screwed on one end (or in some embodiments both ends) of the inner roller 200, such that the ball may be use separately by unscrewing it from the end of the inner roller 200. In one embodiment, the inner roller may include a bar and a plurality of balls. The plurality of balls may each have an opening formed therethrough so that the bar may pass therethrough for stacking the balls on the bar. A closure may be provided on each end of the bar for keeping the balls in place. A user may use the bar with the balls as a massage roller or may take one or more balls off of the bar (by removing the closure) and use the balls separately for a massage.

According to one embodiment, there is provided a massage device 100, comprising: a hollow cylindrical outer roller 300 having a first texture 380 formed on an outer surface 330 thereof; and, a cylindrical inner roller 200 having a second texture 280 formed on an outer surface 230 thereof and sized to fit concentrically within the hollow cylindrical outer roller 300; wherein the cylindrical inner roller 200 is moveable between a first position 201 within the hollow cylindrical outer roller 300 and a second position 202 outside of the hollow cylindrical outer roller 300. In the massage device 100, the cylindrical inner roller 200 may be a solid cylindrical inner roller 200. The fit between the inner and outer rollers 200, 300 in the first position 101 may be a snug friction fit. In the first position 101, the inner and outer rollers 200, 300 may be usable together. In the second position 102, the inner roller 200 may be usable separately. In the second position 102, the inner and outer rollers 200, 300 may be usable separately. The outer roller 300 may be made from a first foam material having a first compressibility, the inner roller 200 may be made from a second foam material having a second compressibility, and the first compressibility may be greater than the second compressibility. In one embodiment, the outer and the inner rollers 300, 200 may be made or the same material or different materials with the same compressibility. In another embodiment, the second compressibility (of the inner roller 200) may be greater than the first compressibility (of the outer roller 300).

In operation, according to the first configuration of use 700 as shown in FIG. 7 where the inner roller 200 is fully inserted into the outer roller 300 and the two rollers 200, 300 are used together, the user places the massage device 100 on the floor or ground (or against another surface such as a wall) 800 and then positions the muscle, muscles, or muscle group 1010 of the user's body 1000 that the user wishes to massage in contact with the top surface 710 of the massage device 100. The user then rolls his or her body 1000 back and forth over the massage device 100 which applies a varying pressure to the muscle, muscles, or muscle group to affect the massage. The intensity or depth of the massage received will depend on the texture 380 of the outer surface 330 of the outer roller 300 including the depth and spacing of grooves 381 thereon and on the relative compressibility of the inner and outer rollers 200, 300. The shallow and closely spaced grooves 381 of the outer roller 300 may be effective for massaging large muscle groups such as hamstrings, quadriceps, and deltoids. Of course, the massage device 100 may be used on other muscle groups as well. Advantageously, the wave pattern 383 of the longitudinal grooves 381 of the outer roller 300 allows the user to direct the massage at a particular portion of a muscle or muscle group 1010 without having to move off the massage device 100 in order to reposition the device 100.

According to the second configuration of use 2200 as shown in FIG. 22 where the inner roller 200 is fully removed from the outer roller 300 and the inner roller 200 is used alone, the user places the inner roller 200 on the floor or ground (or against another surface such as a wall) 800 and then positions the muscle, muscles, or muscle group 1020 of the user's body 1000 that the user wishes to massage in contact with the outer surface 230 of the inner roller 200 of the massage device 100. The user then rolls his or her body 1000 back and forth over the inner roller 200 which applies a varying pressure to the muscle, muscles, or muscle group 1020 to affect the massage. The intensity or depth of the massage received will depend on the texture 280 of the outer surface 230 of the inner roller 300 including the depth and spacing of grooves 281 thereon and on the compressibility of the inner roller 200. The deep and widely spaced grooves 281 of the inner roller 200 may be effective for massaging small muscle groups such as those of the back. Of course, the inner roller 200 may be used on other muscle groups as well. Advantageously, the smaller outside diameter 250 and larger grooves 281 of the inner roller 200 allow the user to direct the massage at a particular portion of a muscle or muscle group 1020 with greater precision.

According to the optional third configuration of use 1500 as shown in FIG. 15 where the inner roller 200 is fully removed from the outer roller 300 and the outer roller 300 is used alone, the user places the outer roller massage device 100 on the floor or ground (or against another surface such as a wall) 800 and then positions the muscle, muscles, or muscle group 1010 of the user's body 1000 that the user wishes to massage in contact with the top surface 1510 of the massage device 100. The user then rolls his or her body 1000 back and forth over the outer roller 300 which applies a varying pressure to the muscle, muscles, or muscle group to affect the massage. The intensity or depth of the massage received will depend on the texture 380 of the outer surface 330 of the outer roller 300 including the depth and spacing of grooves 381 thereon and on the compressibility of the outer roller 300. As mentioned above, the shallow and closely spaced grooves 381 of the outer roller 300 may be effective for massaging large muscle groups such as hamstrings, quadriceps, and deltoids. Of course, the outer roller 300 may be used on other muscle groups as well. Advantageously, without the stiffness added by the inner roller 200, when the outer roller 300 is used alone it may provide a relatively gentle massage depending on the compressibility of the outer roller 300. If the outer roller 300 is very compressible, it may deform to a certain extent under the weight of the user's body 100 which will lessen the intensity of the massage. In such a case, the outer roller 300 may also be used as a headrest, for example, while the inner roller 200 is used to affect the massage. In one method of operation, the user may use both rollers 200 and 300 simultaneously to massage different parts of the body. For example, the outer roller 300 may be used to massage the user's hamstrings while the inner roller 200 may be used to massage the thighs or other tight muscles.

The above embodiments may contribute to an improved massage device 100 and may provide one or more advantages. First, the two rollers 200, 300 of the massage device 100 provide a user with a choice of massage textures 280, 380, groove sizes 282, 382, groove geometries 283, 383, and roller outside diameters 250, 350 all in one portable package. Second, the massage device 100 provides a choice of roller compressibilities as the inner and outer rollers 200, 300 have different levels of compressibility.

The embodiments of the application described above are intended to be examples only. Those skilled in the art will understand that various modifications of detail may be made to these embodiments, all of which come within the scope of the application.

What is claimed is:

1. A massage device, comprising:
a hollow cylindrical outer roller having a first texture formed on an outer surface thereof;
and,
an inner roller having a second texture formed on an outer surface thereof and sized to fit concentrically within the hollow cylindrical outer roller;
wherein the inner roller is moveable between a first position within the hollow cylindrical outer roller and a second position outside of the hollow cylindrical outer roller.

2. The massage device of claim 1, wherein the inner roller is a solid cylindrical inner roller.

3. The massage device of claim 1, wherein the inner roller is a hollow cylindrical roller.

4. The massage device of claim 3, further comprising one or more pouches disposed within the inner roller, the one or more pouches being at least one of microwavable and freezable for temperature control.

5. The massage device of claim 3, wherein the inner roller is closed at one end thereof and wherein an inflating port with a closure is formed at an opposite end thereof to inflate or deflate the inner roller by changing a pressure in an inner cavity of the inner roller.

6. The massage device of claim 1, further comprising a ball that is removably attached to one end of the inner roller.

7. The massage device of claim 1, wherein the inner roller has a bar, a plurality of balls with respective holes formed therethrough stacked on the bar, and a closure removably attached to each end of the bar.

8. The massage device of claim 1, wherein the outer roller is made from a first foam material having a first compressibility, and wherein the inner roller is made from a second foam material having a second compressibility.

9. The massage device of claim 1, wherein at least one of the outer and inner rollers has a modular configuration having two or more modules attachable one to each other to form the respective outer and inner rollers.

10. The massage device of claim 1, wherein respective first and second end surfaces of the inner and outer rollers are flat or approximately flat.

11. The massage device of claim 1, wherein the outer roller further comprising a sleeve, the outer roller being insertable into the sleeve.

12. The massage device of claim 11, wherein the sleeve has one or more independent parts, each part having a different texture and/or compressibility.

13. The massage device of claim 1, wherein the inner roller further comprising a sleeve, the inner roller being insertable into the sleeve.

14. The massage device of claim 13, wherein the sleeve has one or more independent parts, each part having a different texture and/or compressibility.

15. The massage device of claim 1, further comprising a handle foil led on at least one end of the massage device.

16. The massage device of claim 15, wherein the handle is a handle bar extending outwardly from an end surface of the inner roller.

17. The massage device of claim 1, further comprising a belt with a respective connector disposed on each end thereof for removably connecting to a respective handle formed on each end of the massage device.

18. The massage device of claim 1, wherein the first texture is formed by a plurality of longitudinal grooves.

19. The massage device of claim 18, wherein each longitudinal groove extends between first and second ends of the outer roller tracing out a transverse wave-shaped pattern having a first curved crest portion proximate the first end of the outer roller, a flattened trough portion proximate a midpoint of the outer roller, and a second curved crest portion proximate the second end of the outer roller.

20. The massage device of claim 19, wherein each longitudinal groove is one of V-shaped or approximately V-shaped in cross-section and sinusoidal or approximately sinusoidal in axial cross-section.

21. The massage device of claim 1, wherein the second texture is formed by a plurality of transverse grooves.

22. The massage device of claim 21, wherein each transverse groove is an annular groove.

23. The massage device of claim 22, wherein each transverse groove is one of V-shaped or approximately V-shaped in cross-section and sinusoidal or approximately sinusoidal in cross-section.

24. The massage device of claim 3, wherein the inner roller has an accessible cavity formed therein for storage of one or more massage accessories or balls.
